(19) United States
(12) Patent Application Publication
(10) Pub. No.: US 2007/0175101 A1
(43) Pub. Date: Aug. 2, 2007

(54) Glass run channel

(75) Inventors: Osamu Kanehara, Aichi (JP); Masaki Shiraiwa, Aichi (JP)

Correspondence Address: OLIFF & BERRIDGE, PLC, P.O. BOX 19928, ALEXANDRIA, VA, 22320, US

(73) Assignee: tokai Kogyo co ltd, aichi (JP)

(21) Appl. No.: 10/591,277

(22) PCT Filed: Mar. 2, 2005
(86) PCT No.: PCT/JP05/03454

§ 371 Date: Aug. 31, 2006

(30) Foreign Application Priority Data
Mar. 5, 2004 (JP) 2004-061511

(51) Int. Cl. E06B 7/16

(52) U.S. Cl. 49/441

(57) ABSTRACT

An object of the present invention is to reduce or prevent noise during a slide movement of a window pane for a long period of time. A plurality of projecting ridges 30 and 31 are formed on surfaces of interior and exterior sealing lips 24 and 25 of a glass run channel to be mounted on a window frame, so as to be substantially in parallel to each other along a lengthwise direction of the sealing lips 24 and 25. Each of main projecting ridges 30 and 31 is formed so that a cross-sectional shape thereof becomes substantially a scalene triangle including a longer side at a root side of each of the sealing lips 24 and 25 and a shorter side at a distal end side of the sealing lips 24 and 25. The longer side of the projecting ridge 30 and 31 is set so as to have an inclination angle α ranging from 40° to 80° relative to a normal line on the surface of the sealing lip bodies 26 and 27 and the shorter side of the projecting ridge 30 and 31 is set so as to have an angle of inclination ranging from 5° to 40° or more preferably, from 15° to 40° relative to the normal line. As a result, frictional force acting on the projecting ridges 30 and 31 of the sealing lips 24 and 25 during movement of the window pane 14 is rendered smaller as compared with the conventional structure and accordingly, the sliding characteristic between the window pane 14 and the sealing lips 24 and 25 is maintained at a favorable state.

### TECHNICAL FIELD

The present invention relates to a glass run channel which is mounted along a window frame of a vehicle for guiding a slide movement of a window pane.

### BACKGROUND ART

In a window structure of a vehicle, a long glass run channel is generally mounted along an inner periphery of a door window frame to guide a window pane moving up and down (slide movement). The glass run channel includes a base bottom portion opposed to a peripheral edge of the window pane, interior and exterior side wall portions formed so as to rise from both widthwise ends of the base bottom portion and interior and exterior sealing lips each of which is formed so as to extend from the distal end side of the corresponding side wall portion toward the substantially widthwise central side of the base bottom portion. Each sealing lip can be abutted against the surface of the window pane so that the window pane is held and seal is provided between the window frame and the window pane.

In the above-described glass run channel, several techniques of reducing sliding resistance during up and down movement of the window pane have been proposed in order that a window pane may smoothly be moved up and down. For example, patent document 1 (JP-A-2000-16090) describes that a plurality of projecting ridges each of which has a generally semicircular section are provided on the surface of each sealing lip so as to extend in the lengthwise direction (in the direction of movement of the window pane) so that a contact area of each sealing lip with the window pane is reduced, whereby the sliding resistance produced during upward and downward movement of the window pane is reduced.

Furthermore, patent document 2 (JP-A-H05-330345) describes that a low-frictional material layer having a lower friction coefficient relative to the window pane is provided on the surface of each sealing lip so that the sliding resistance during up and down movement of the window pane is reduced.

Patent document 1: JP-A-2000-16090

Patent document 2: JP-A-H05-330345

### DISCLOSURE OF THE INVENTION

### Problem to be Overcome by the Invention

In the aforesaid conventional glass run channels, however, repeated up and down movement of the window pane tends to cause the projecting ridges or the low-frictional material layer on the surface of the sealing lips to rub against the window pane thereby to be worn out. Depending upon usage environment, the projecting ridges or the low-frictional material wears out relatively in a shorter period of time such that frictional force (sliding resistance) during up and down movement of the window pane is increased. As a result, the conventional glass run channels have a defect that the window pane is caused to rub against the sealing lips during up and down movement thereof, thereby tending to occur an unpleasant noise (rubbing noise).

The present invention was made in view of the foregoing circumstances and an object of the present invention is to provide a glass run channel which can reduce or prevent the noise during slide movement of the window pane for a long period of time.

### Means for Overcoming the Problem

To achieve the aforementioned object, a long glass run channel described in claim 1 of the present invention is made from an elastic polymer material, the glass run channel being mounted along a window frame of a vehicle and formed so as to guide a slide movement of a window pane, the glass run channel including a base bottom portion opposed to a peripheral end surface of the window pane when the glass run channel has been mounted on the window frame, interior and exterior side wall portions standing from both ends of the base bottom portion in the width direction respectively, and interior and exterior sealing lips protruding from distal end sides of the interior and exterior side wall portions toward widthwise substantially central sides of the base bottom portion respectively, the interior and exterior sealing lips being capable of abutting against the window pane when the glass run channel is mounted on the window frame, comprising at least one of the interior and exterior sealing lips includes a sealing lip body and a projecting ridge formed integrally on a surface of the sealing lip body so as to extend in a lengthwise direction, and the projecting ridge has a cross section formed into the shape of substantially a scalene triangle including a longer side at a root side of the sealing lip and a shorter side at a distal end side of the sealing lip.

The following is a reason for that the window pane is caused to rub against the sealing lips during up and down movement thereof, thereby tending to produce noise. That is, the distal end sides of the sealing lips are elastically deformed in the direction of movement of the window pane by a frictional force between the window pane and the sealing lips, whereby when the elastic repulsive force of the sealing lips exceeds the frictional force, it causes the distal end sides of the sealing lips to return to the original shapes. In the process of return, the sealing lips strike the surfaces of the window panes with short quick steps (so-called a stick slip phenomenon) repeatedly in a short period of time, whereby the noise is considered to be happened. In this case, the sealing lips are gotten caught up in a vicious cycle that when the frictional force is large, sliding portions of the sealing lips are easily worn and the wear further increases the frictional force such that the noise is increased.

Accordingly, in the present invention, a projecting ridge of the sealing lip is formed integrally on a surface of the sealing lip body so as to extend in a lengthwise direction as means for reducing the frictional force between the window pane and the projecting ridge of the sealing lip during slide movement of the window pane and the projecting ridge has a cross section formed into the shape of substantially a scalene triangle including a root side of the sealing lip serving as a longer side and a distal end side of the sealing lip serving as a shorter side. When the projecting ridge with such a sectional shape is used, as obvious from the results of an experiment which will be described later, frictional force acting on the projecting ridge of the sealing lip can be rendered smaller as compared with the prior art, an amount of wear of the projecting ridge can be reduced, and the frictional force and amount of wear can be maintained at a smaller state for a long period of time. Consequently, the sliding characteristic between the window pane and the sealing lips can remain good, and noise can be reduced or prevented during slide movement of the window pane for a long period of time.

In this case, it is good that the longer side of the projecting ridge is set so as to have an angle of inclination ranging from 40° to 80° relative to a normal line on the surface of the sealing lip body and that the shorter side of the projecting ridge is set so as to have an angle of inclination ranging from 5° to 40° relative to the normal line. According to the results of the experiment conducted by the inventor, when the inclination angle of the longer side of the projecting ridge is increased over 80°, a contact area between the longer side and the window pane is excessively increased such that frictional force tends to be noticeably increased. Furthermore, when the inclination angle of the longer side is reduced below 40°, an inclination angle of the longer side relative to the window pane becomes excessively steep such that a window pane holding function and a sealing performance are noticeably reduced and the strength of the projecting ridge tends to become insufficient. On the other hand, when the inclination angle of the shorter side of the projecting ridge is increased over 40°, a contact area between the shorter side and the window pane is excessively increased such that frictional force tends to be noticeably increased. Furthermore, when the inclination angle of the shorter side is reduced below 5°, an inclination angle of the shorter side relative to the window pane becomes excessively steep such that a window pane holding function and a sealing performance are noticeably reduced and the strength of the projecting ridge tends to become insufficient. Accordingly, the frictional force during the movement of the window pane can effectively be reduced when the inclination angle of the longer side ranges from 40° to 80° and the inclination angle of the shorter side ranges from 5° to 40° or more preferably, from 15° to 40°.

The projecting ridge can be made from a polymer material having a solubility with a polymer material of the sealing lip body and a better slidability than that of the polymer material of the sealing lip body and that that of the projecting ridge and the sealing lip body can be integrated by welding. Consequently, the projecting ridge and the sealing lip can be integrated by welding while being formed simultaneously by co-extrusion molding and accordingly, the glass run channel can efficiently be produced and the frictional force during movement of the window pane can reliably be rendered smaller, whereupon an effect of preventing noise can be improved.

In this case, the polymer material of the sealing lip body may be rubber. Rubber generally has an outstanding elastic repulsive force and less permanent strain and accordingly, the sealing lips can hold the window pane well and stably for a long period of time.

Alternatively, the polymer material of the sealing lip body may be a thermoplastic elastomer. Consequently, the sealing lip can easily be manufactured by extrusion molding which is similar to extrusion molding for a normal thermoplastic resin.

In this case, the thermoplastic elastomer of the sealing lip body may be preferably an olefinic thermoplastic elastomer. Since the olefinic thermoplastic elastomer has a smaller specific gravity than other polymer materials, the weight of the glass run channel can be reduced when the sealing lip body is made from the olefinic thermoplastic elastomer.

Meanwhile, since the exterior sealing lip is more frequently subject to dirt, sand or dust than the interior sealing lip, an amount of wear of the projecting ridge of the exterior sealing lip is rendered larger than the projecting ridge of the interior sealing lip such that the frictional force tends to be increased with lapse of time, whereupon a problem of noise during movement of the window pane is apt to occur.

Furthermore, in some types of vehicles, a center of the window pane in the direction of a thickness thereof is shifted to the exterior side relative to the widthwise center of the window frame (the widthwise center of the glass run channel) so that a step between the exterior sealing lip and the window pane is reduced as less as possible so that a whistle noise during driving is reduced. In such a case, since a frictional force is rendered larger in the exterior sealing lip than in the interior sealing lip, a problem of noise during movement of the window pane is apt to occur.

In view of these circumstances, the projecting ridge can be provided at least a surface of the exterior sealing lip body out of the interior and exterior sealing lips. Consequently, the problem of noise in the exterior sealing lip during movement of the window pane can be overcome by a frictional force reducing effect of the projecting ridge with an inequilateral triangular cross section.

Alternatively, the projecting ridges can be provided on surfaces of both interior and exterior sealing lips respectively. Consequently, noise can be prevented from being produced during movement of the window pane in both interior and exterior sealing lips.

A glass run channel generally comprises an upper glass run channel mounted along an upper part of the window frame and a side glass run channel mounted along a side part of the window frame. Sealing lips of the upper glass run channel only contact with the window pane when the window pane is full closed. Accordingly, the problem of noise during movement of the window pane is apt to occur in the side glass run channel more frequently than in the upper glass run channel.

Accordingly, the projecting ridge can be provided on the sealing lips of the side glass run channel. Consequently, the problem of noise in the sealing lips of the side glass run channel during movement of the window pane can be overcome.

However, the projecting ridges may of course be provided on the sealing lips of both upper and side glass run channels. Consequently, a forming die can be used for both upper and side glass run channels.

Furthermore, a plurality of the projecting ridges can be provided substantially in parallel with each other along the lengthwise direction of the sealing lip. Consequently, even when the window pane and each sealing lip are dimensionally shifted from each other, any one or more of the projecting ridges can be brought into contact with the window pane, whereupon the surface of each sealing lip body (part other than the projecting ridges) can be prevented from direct contact with the window pane and production of noise.

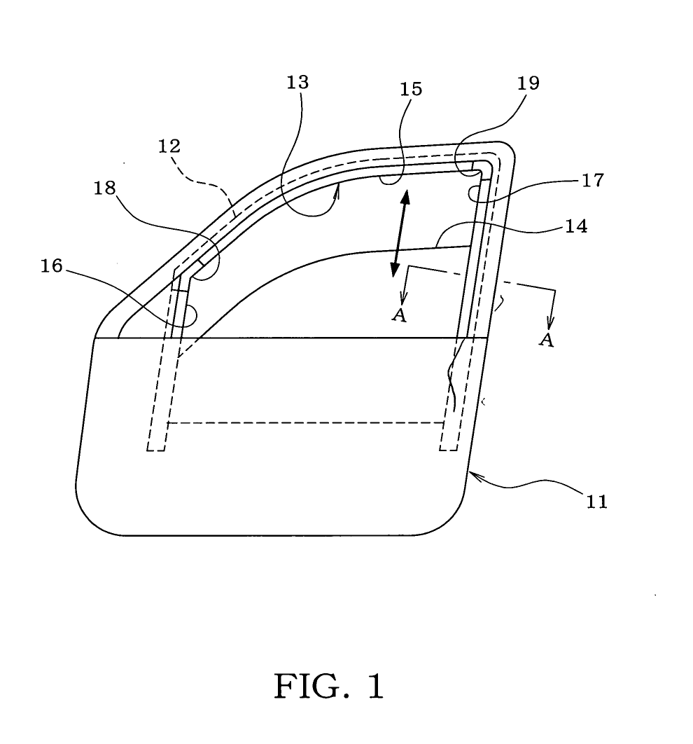

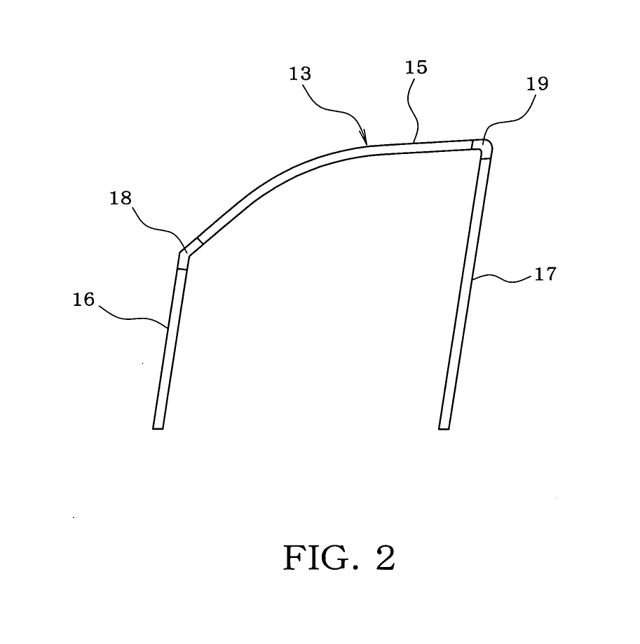

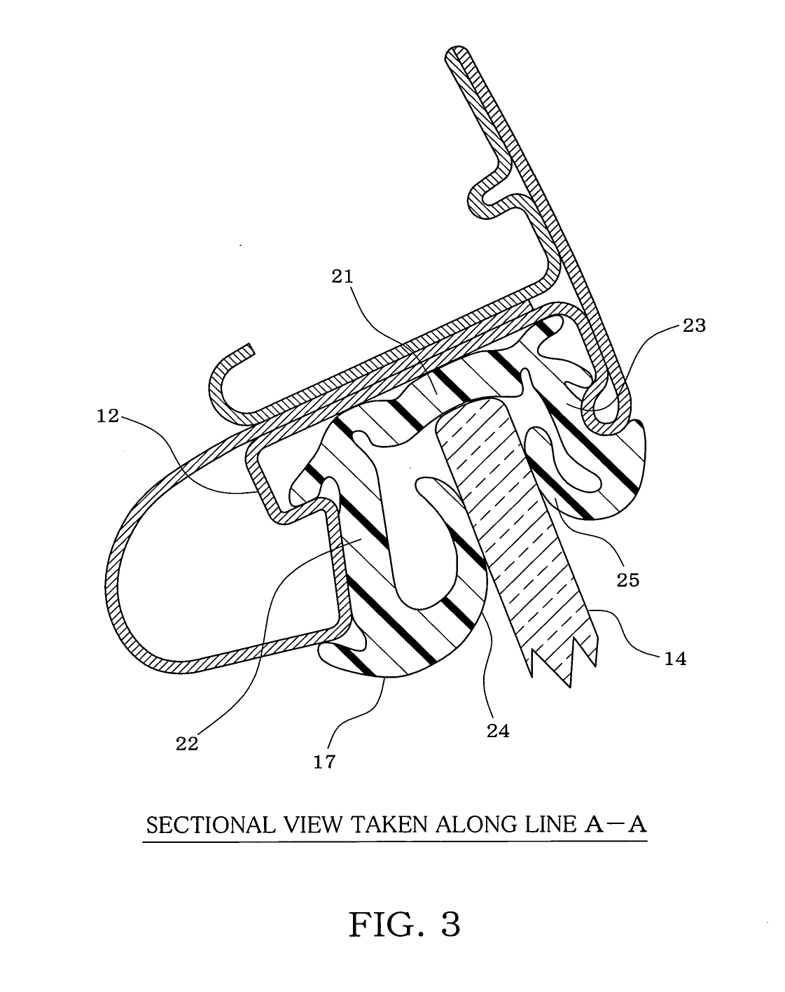

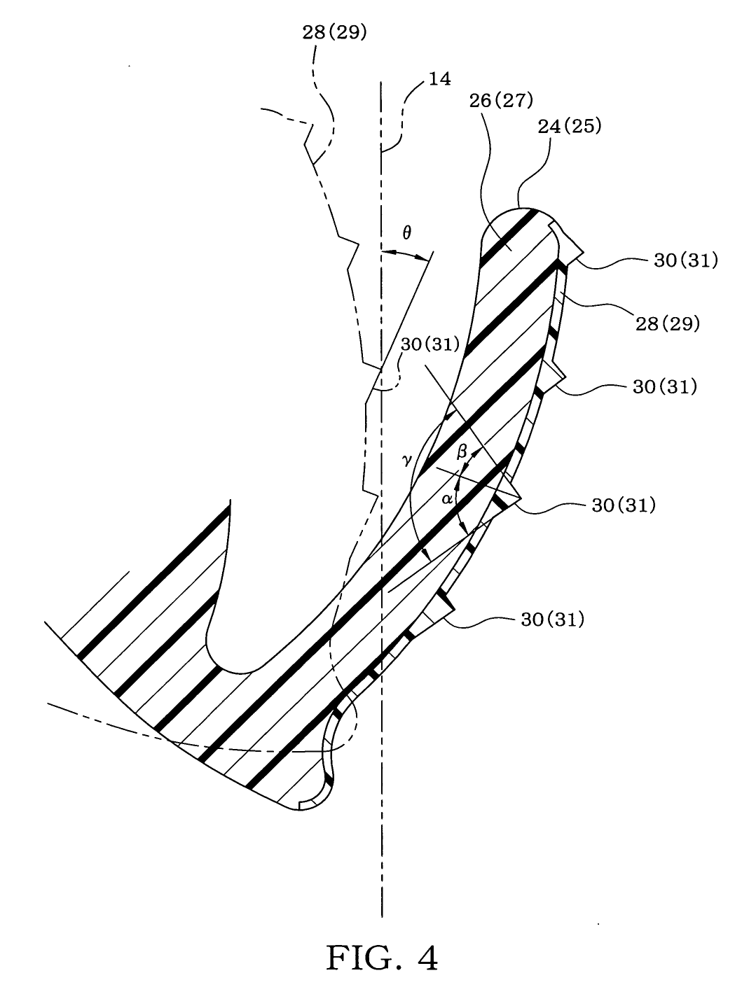

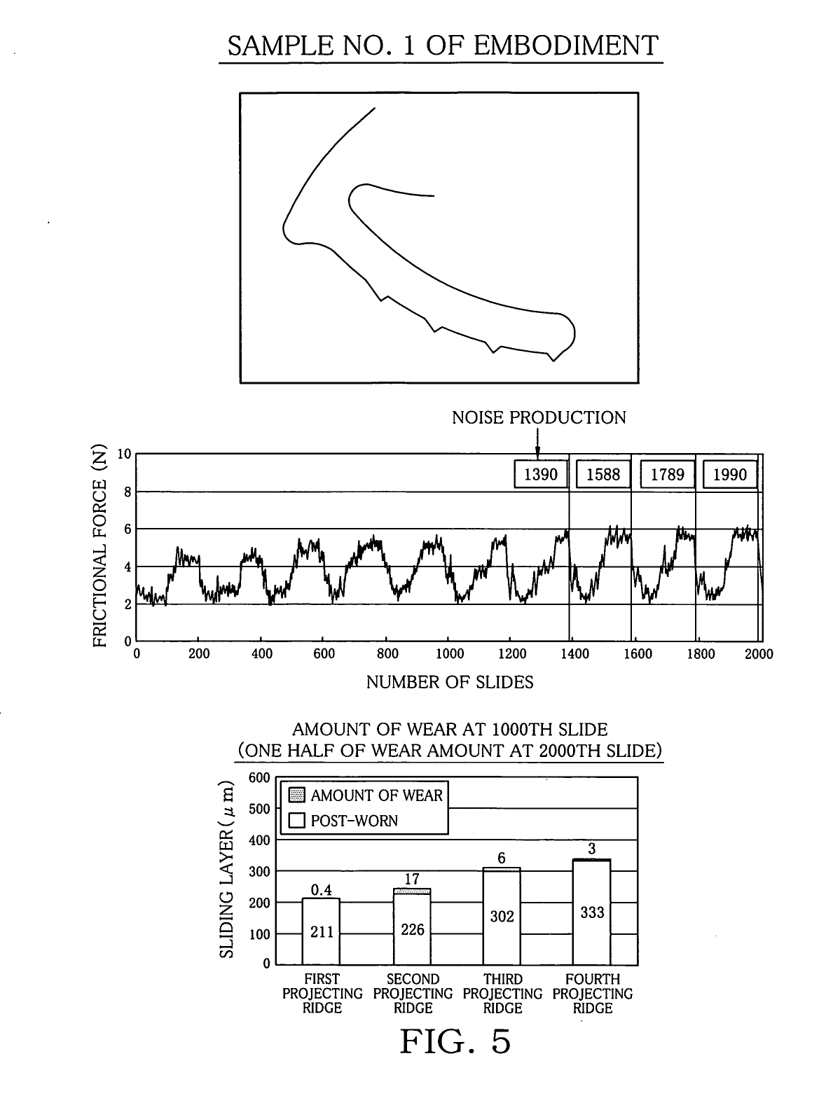

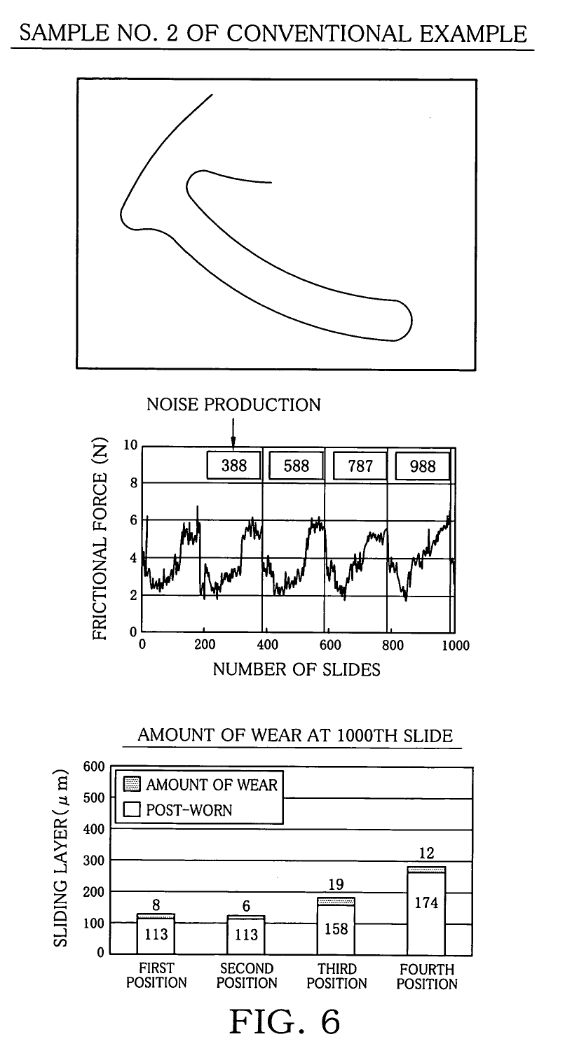

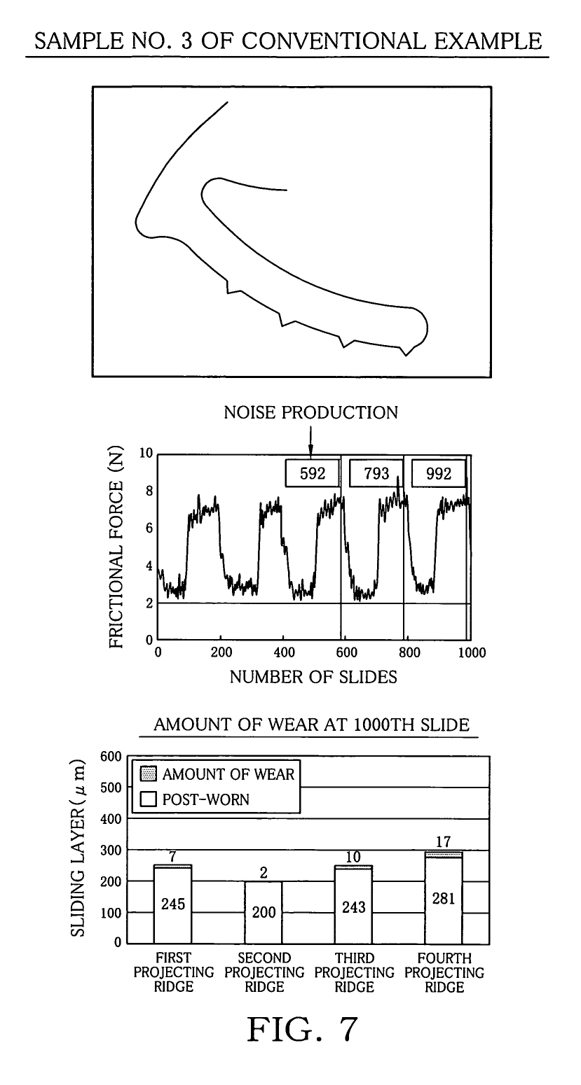

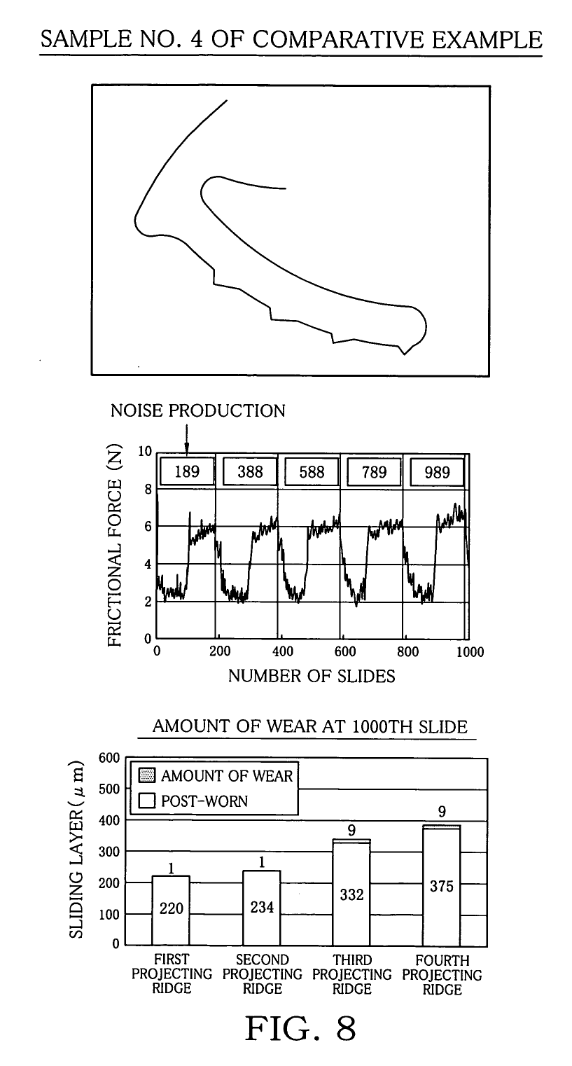

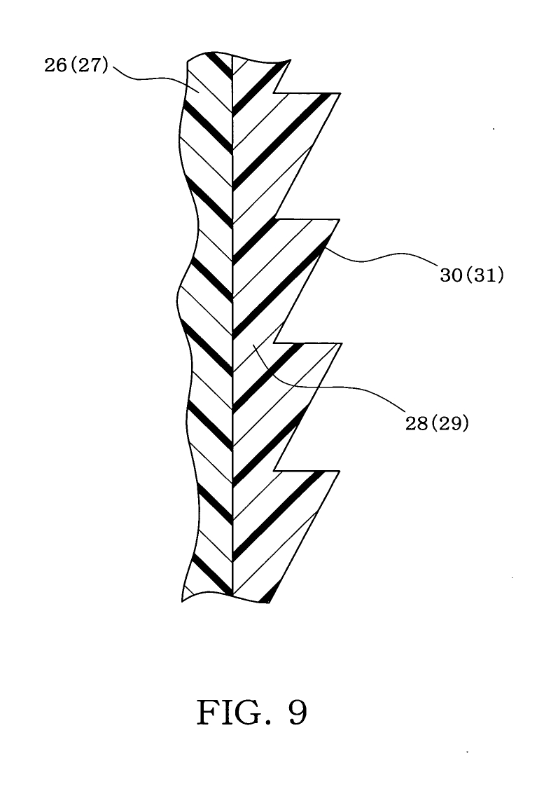

### BRIEF DESCRIPTION OF THE DRAWINGS

[FIG. 1] FIG. 1 is a schematic view showing a door on which a glass run channel assembly is mounted in accordance with one embodiment of the present invention;

[FIG. 2] FIG. 2 is afront view of the glass run channel assembly;

[FIG. 3] FIG. 3 is a cross sectional view taken along line A-A in FIG. 1;

[FIG. 4] FIG. 4 is an enlarged cross section of a sealing lip;

[FIG. 5] FIG. 5 is a view explaining sample No. 1 of the embodiment and the experimental results;

[FIG. 6] FIG. 6 is a view explaining sample No. 2 of a conventional example and the experimental results;

[FIG. 7] FIG. 7 is a view explaining sample No. 3 of a conventional example and the experimental results;

[FIG. 8] FIG. 8 is a view explaining sample No. 4 of a comparative example and the experimental results; and

[FIG. 9] FIG. 9 is an enlarged section of a projecting ridge and periphery thereof in another embodiment.

### EXPLANATION OF REFERENCE SYMBOLS

11 . . . door, 12 . . . window frame, 13 . . . glass run channel assembly, 14 . . . window pane, 15 . . . upper glass run channel, 16 . . . front glass run channel, 17 . . . rear glass run channel, 18 . . . front cornerglass run channel, 19 . . . rear corner glass run channel, 21 . . . base bottom portion, 22, 23 . . . side wall portion, 24, 25 . . . sealing lip, 26, 27 . . . sealing lip body, 28, 29 . . . low-frictional material layer, and 30, 31 . . . projecting ridge.

### BEST MODE FOR CARRYING OUT THE INVENTION

One embodiment in which the present invention is applied to a glass run channel mounted on a window frame of an automobile will be described with reference to the drawings.

Firstly, a schematic construction of a door 11 will be described with reference to FIG. 1. A window frame 12 is provided integrally on the door 11. A long glass run channel assembly 13 made from an elastic polymer material is mounted along the window frame 12, and an upward and downward movement (slide movement) of a window pane 14 is adapted to be guided by the glass run channel assembly 13.

The glass run channel assembly 13 is composed of a long upper glass run channel 15 mounted along an upper part of the window frame 12 (a part corresponding to roof and front pillar), a long front glass run channel 16 mounted along a front side of the window frame 12 (a part corresponding to partition), a long rear glass run channel 17 mounted along a rear side of the window frame 12 (a part corresponding to a center pillar), a front corner glass run channel 18 joining the upper and front glass run channels 15 and 16 to each other, and a rear corner glass run channel 19 joining the upper and rear glass run channels 15 and 17 to each other as shown in FIGS. 1 and 2.

As the elastic polymer material of the glass run channel assembly 13 is used, for example, a thermoplastic elastomer such as olefin thermoplastic elastomer (TPO) or a rubber such as ethylene-propylene-diene copolymer (EPDM) containing olefin component. The upper, front and rear glass run channels 15, 16 and 17 are formed into respective linear shapes by extrusion molding or the like. Furthermore, the front and rear corner glass run channels 18 and 19 are each formed into respective curved shapes according to the corners of the window frame 12 by insert injection molding or the like.

In this case, a front end of the upper glass run channel 15 and an upper end of the front glass run channel 16 are set (inserted) in an injection mold for the front corner glass run channel 18 by crossing each other at a predetermined angle. In this state, the elastic polymer material is injected into the injection mold so that the front corner glass run channel 18 is formed, whereby the upper and front glass run channels 15 and 16 are joined together via the front corner glass run channel 18.

A rear end of the upper glass run channel 15 and an upper end of the rear glass run channel 17 are set in an injection mold for the rear corner glass run channel 19 by crossing each other at a predetermined angle. In this state, the elastic polymer material is injected into the injection mold so that the rear corner glass run channel 19 is formed, whereby the upper and rear glass run channels 15 and 17 are joined together via the rear corner glass run channel 19.

The structure of the rear glass run channel 17 will be described with FIGS. 3 and 4. As shown in FIG. 3, the rear glass run channel 17 includes a base bottom portion 21 opposed to a peripheral edge of the window pane 14, an interior side wall portion 22 and an exterior side wall portion 23 which stand from both ends of the base bottom portion 21 in the width direction respectively, an interior sealing lip 24 and an exterior sealing lip 25 which protrude from distal end sides of the interior and exterior side wall portions 22 and 23 toward widthwise substantially central sides of the base bottom portion 21 respectively are formed integrally into a folded shape. The interior and exterior sealing lips 24 and 25 abut against the surfaces of the window pane 12 when the glass run channel assembly 13 is mounted on the window frame 12, thereby holding the window pane 14 and providing a seal between the window frame 12 and the window pane 14.

The structures of the interior and exterior sealing lips 24 and 25 will be described with reference to FIG. 4. Since the interior and exterior sealing lips 24 and 25 have substantially the same structure, FIG. 4 shows a sectional view common to both sealing lips.

Low-frictional material layers 28 and 29 are formed integrally on the surfaces of the sealing lip bodies 26 and 27 of the interior and exterior sealing lips 24 and 25 respectively as shown in FIG. 4. The low-frictional material layers 28 and 29 have surfaces on which a plurality of (four, for example) projecting ridges 30 and 31 are formed integrally. The projecting ridges 30 and 31 are formed so as to be approximately in parallel to each other along the lengthwise directions of sealing lips 24 and 25 (in the direction of movement of the window pane 14) at predetermined intervals. Consequently, friction coefficients and contact areas of the sealing lips 24 and 25 relative to the window pane 14 are reduced so that the friction force (sliding resistance) is decreased. In the following, the projecting ridges 30 and 31 will be referred to as first to fourth projecting ridges sequentially from the distal end sides of the sealing lips 24 and 25 for the sake of convenience in the description.

In the embodiment, each of the first to fourth projecting ridges 30 and 31 is formed so that a cross-sectional shape substantially becomes a scalene triangle including a root side of the sealing lip 24 or 25 serving as a longer side and a distal end side of the sealing lip 24 or 25 serving as a shorter side. The longer side of each of the second to fourth projecting ridges 30 and 31 is set so as to have an inclination angle α ranging from 40° to 80° relative to a normal line passing apexes of the projecting ridges 30 and 31 on the surfaces of the sealing lip bodies 26 and 27 and the shorter side is set so as to have an inclination angle β ranging from 5° to 40° (or more preferably, from 15° to 40°) relative to the normal line.

According to the results of an experiment conducted by the inventor, when the inclination angle α of the longer side of each of the projecting ridges 30 and 31 is increased over 80°, a contact area between the longer side and the window pane 14 is excessively increased such that frictional force tends to be noticeably increased. Furthermore, when the inclination angle α of the longer side is reduced below 40°, an inclination angle of the longer side relative to the window pane 14 becomes excessively steep such that a window pane holding function and a sealing performance are noticeably reduced and the strength of each of the projecting ridges 30 and 31 tends to become insufficient. On the other hand, when the inclination angle β of the shorter side of the projecting ridge is increased over 40°, a contact area between the shorter side and the window pane 14 is excessively increased such that frictional force tends to be noticeably increased. Furthermore, when the inclination angle β of the shorter side is reduced below 5°, an inclination angle of the shorter side relative to the window pane 14 becomes excessively steep such that a window pane holding function and a sealing performance are noticeably reduced and the strength of each of the projecting ridges 30 and 31 tends to become insufficient. Accordingly, the frictional force during the movement of the window pane 14 can effectively be reduced when the inclination angle α of the longer side ranges from 40° to 80° and the inclination angle β of the shorter side ranges from 5° to 40° or more preferably, from 15° to 40°.

Each of the first projecting ridges 30 and 31 is formed so that a sectional configuration becomes a scalene triangle approximate substantially to an isosceles triangle. The reason for this is that when the first projecting ridges 30 and 31 mounted on the respective distal end sides of the sealing lips 24 and 25 have an extremely inequilaterally triangular sectional configuration, a contact area with the window pane 14 is excessively large such that frictional force tends to be increased.

Inclination angles α and β of the sides of the second to fourth projecting ridges 30 and 31 are set so that the second to fourth projecting ridges 30 and 31 have substantially the same apex angle γ (=α+β; and about 90°, for example). Inclination angles α and β of the sides of the first projecting ridges 30 and 31 are set so that the first projecting ridges 30 and 31 have smaller apex angles γ (about 80°, for example) than the second to fourth projecting ridges 30 and 31 respectively, and inclination angles α and β of the respective sides are set so that inclination angles θ of longer sides (sides located at the root sides of the sealing lips 24 and 25) relative to the surfaces of the window pane 14 are approximately the same (about 24°, for example) when the sealing lips 24 and 25 abut against the surfaces of the window pane 14 thereby to be elastically deformed, as shown in two-dot chain line in FIG. 4. Consequently, the frictional force during the movement of the window pane 14 can effectively be reduced as described above.

A polymer material of the projecting ridges 30 and 31 and the low-frictional material layer 28 and 29 is selected so as to have a solubility with a polymer material of the sealing lip bodies 26 and 27 (that is, the rear glass run channel 17) and so as to have a better slidability than the polymer material of the sealing lip bodies 26 and 27. For example, a thermoplastic elastomer such as TPO or a rubber such as EPDM is used. In the case, when the rubber for example EPDM is used, the projecting ridges 30 and 31 are made from rubber and the surface is covered with a low-frictional material layer of an urethane resin coating or the like.

When the projecting ridges 30 and 31 and the low-friction material layers 28 and 29 are made from the thermoplastic elastomer, a thermoplastic elastomer having a higher ratio of resin component than that of the sealing lip bodies 26 and 27 (that is, a lower ratio of rubber component) or a thermoplastic elastomer kneaded with a material having lubricity (for example, silicone oil, fine powder of fluorine resin, fine powder of silicone resin, high molecular weight polyethylene or the like) is used.

When the sealing lip bodies 26 and 27, projecting ridges 30 and 31 and low-friction material layers 28 and 29 are made from a thermoplastic elastomer such as TPO, the sealing lip bodies 26 and 27 having a Durometer hardness ranging from 60 HDA to 80 HDA according to Japanese Industrial Standards (JIS) K7215, the projecting ridges 30 and 31, and the low-frictional material layers 28 and 29 with the Durometer hardness ranging from 40 HDD to 55 HDD are joined by welding to be integrated while being simultaneously molded by co-extrusion molding.

Furthermore, when the sealing lip bodies 26 and 27 are made from a rubber such as EPDM or the like, the projecting ridges 30 and 31 are also integrally made from a rubber such as EPDM or the like and thereafter, the surfaces of the sealing lips 24 and 25 are coated with a lubricating layer such as urethane coating, or the sealing lip bodies 26 and 27 are extruded and vulcanized and thereafter, the olefin component in the TPO and the olefin component in the EPDM are joined by welding thereby to be integrated while molding the projecting ridges 30 and 31 and low-frictional material layers 28 and 29 made from thermoplastic elastomer such as TPO by a two-stage extrusion molding.

The front glass run channel 16 and upper glass run channel 15 have substantially the same configuration as the above-described rear glass run channel 17 and accordingly, the description of the front glass run channel 16 and upper glass run channel 15 will be eliminated. However, the projecting ridges 30 and 31 are also formed on the surfaces of the interior and exterior sealing lips 24 and 25 of the front glass run channel 16 and upper glass run channel 15 respectively.

The inventors conducted a wet wear resistance test using sample No. 1 of the embodiment, sample Nos. 2 and 3 of the conventional example, sample No. 4 of the comparative example in order to evaluate the effect of the glass run channel of the embodiment. FIGS. 5 to 8 and TABLE 1 show the results of the test.

Each of sample Nos. 1 to 4 is a sealing lip having a length of about 100 mm. Sample No. 1 (see FIG. 5) of the embodiment is a sealing lip in which each projecting ridge has a cross-section formed into the shape of substantially a scalene triangle including a root side of the sealing lip serving as a longer side. Sample No. 4 of the comparative example (see FIG. 8) is a sealing lip in which each projecting ridge has a cross section formed into the shape of substantially a scalene triangle including a distal end side of the sealing lip serving as a longer side. Furthermore, sample No. 2 of the conventional example (see FIG. 6) is a sealing lip without projecting ridges. Sample No. 3 of the conventional example (see FIG. 7) is a sealing lip in which each projecting ridge has a cross section formed into the shape of substantially a regular triangle.

In the test, while the sealing lips were pressed against the window pane at 10 N of load, 5 cc of water was sprinkled over the sealing lips and the window pane was then slid repeatedly 200 times in the lengthwise direction of the sealing lips, with respect to each of sample Nos. 1 to 4 in order that measurement was made for a frictional force (sliding resistance) applied to each sealing lip, an amount of wear in each projecting ridge (or surface of each sealing lip) and the number of times of slide movement at which noise starts to be produced. FIGS. 5 to 8 and TABLE 1 show the results of the test.

TABLE 1

| | Frictional | | |
|---|---|---|---|
| | force (N) in | | |
| | drying at | | |
| | initial stage | | Number of times |
| | of test (at | Average amount | of slide at |
| | about 150th | of wear (μm) at | which noise was |
| Sample No. | slide) | 1000th slide | happened |
| No. 1 of the | 4 to 5 | 6.6 | 1390 |
| embodiment | | (½ at 2000th | |
| | | slide) | |
| No. 2 of the | 5 to 7 | 11.3 | 388 |
| conventional | | | |
| example | | | |
| No. 3 of the | 6 to 8 | 9.0 | 592 |
| conventional | | | |
| example | | | |
| No. 4 of the | 5 to 7 | 5.0 | 189 |
| comparative | | | |
| example | | | |

According to the test results as shown in FIGS. 5 to 8 and TABLE 1, the frictional force in the drying was relatively larger from an initial stage after start of the test in each of the conventional example Nos. 2 and 3 and moreover, an average amount of wear at 1000th slide was also relatively larger, whereupon noise was produced at an early time after start of the test.

Furthermore, although the frictional force in the drying was relatively larger from an initial stage af ter start of the test in the comparative example No. 4, an average amount of wear at 1000th slide was relatively smaller. However, noise was produced at an early time after start of the test.

On the other hand, the frictional force in the drying was smaller in the sample No. 1 of the embodiment as compared with the conventional and comparative examples, and moreover, an average amount of wear at 1000th slide (½ at 2000th slide) was relatively smaller, too, whereupon noise was happened quite later than in the conventional and comparative examples.

As obvious from the foregoing test results, the projecting ridges 30 and 31 are provided on the surfaces of the sealing lips 24 and 25 respectively in the embodiment, and each of the projecting ridges 30 and 31 is formed so as to have a cross section formed into the shape of substantially a scalene triangle including a root side of each of the sealing lips 24 and 25 serving as a longer side and a distal end side of the sealing lips 24 and 25 serving as a shorter side. As a result, the frictional force acting on the projecting ridges 30 and 31 of the respective sealing lips 24 and 25 can be rendered smaller as compared with the conventional structure and accordingly, an amount of wear of each of the projecting ridges 30 and 31 can be reduced. The frictional force and amount of wear can thus be maintained at respective smaller values for a long period of time. Consequently, the sliding performance between the widow pane 14 and each of the sealing lips 24 and 25 can remain good, and noise can be reduced or prevented during slide movement of the window pane 14 for a long period of time.

Moreover, the longer side of each of the projecting ridges 30 and 31 is set so as to have an angle of inclination ranging from 40° to 80° relative to a normal line on the surface of each of the sealing lip bodies 24 and 25 and that the shorter side of each of the projecting ridges 30 and 31 is set so as to have an angle of inclination ranging from 5° to 40° (more preferably, from 15° to 40°) relative to the normal line. Consequently, a contact area between each side and the window pane 14 can be rendered smaller without the inclination of each side relative to the window pane 14 being steep, and accordingly, the frictional force created during movement of the window pane 14 can effectively be reduced.

Furthermore, a plurality of the projecting ridges 30 and 31 are provided on the surfaces of the sealing lips 24 and 25 respectively so as to be substantially in parallel with each other. Consequently, even when the window pane 14 and each of the sealing lips 24 and 25 are dimensionally shifted from each other, any one or more of the projecting ridges 30 and 31 can be brought into contact with the window pane 14, whereupon part of each sealing lip 24 and 25 other than the projecting ridges 30 and 31 can be prevented from direct contact with the window pane 14 and production of noise.

Furthermore, in the embodiment, the projecting ridges 30 and 31 and the low-frictional material layers 28 and 29 are each made from a polymer material having a solubility with a polymer material of the sealing lip bodies 26 and 27 respectively and a better slidability than that of the polymer material of the sealing lip bodies 26 and 27. Accordingly, the sealing lip bodies 26 and 27, projecting ridges 30 and 31 and low-frictional material layers 28 and 29 can be integrated by welding while being formed simultaneously by co-extrusion molding. Consequently, the glass run channel can efficiently be produced and the frictional force during movement of the window pane 14 can reliably be rendered smaller, whereupon an effect of preventing noise can be improved.

Furthermore, in the embodiment, the thermoplastic elastomer such as TPO or rubber such as EPDM is used as the polymer material of the sealing lip bodies 26 and 27. When made from the thermoplastic elastomer, the sealing lip bodies 26 and 27 can easily be manufactured by extrusion molding which is similar to extrusion molding for a general thermoplastic resin. Moreover, since TPO has a smaller specific gravity than other polymer materials, the weight of the glass run channel can be reduced when the sealing lip bodies 26 and 27 are made from the olefinic thermoplastic elastomer. Furthermore, since rubber generally has an outstanding elastic repulsion force and less permanent strain, the sealing lip bodies 26 and 27 can hold the window pane 14 well and stably for a long period of time when made of rubber.

Furthermore, since the projecting ridges 30 and 31 are provided on both interior and exterior sealing lips 24 and 25 respectively in the embodiment, production of noise can be prevented in both interior and exterior sealing lips 24 and 25 during movement of the window pane.

Furthermore, the projecting ridges 30 and 31 are provided on all the sealing lips 24 and 25 including all the upper, front and rear glass run channels 15, 16 and 17, respectively. Consequently, an extrusion die can be used for upper, front and rear glass run channels 15, 16 and 17.

However, the projecting ridges 30 and 31 may be provided on only the respective sealing lips 24 and 25 of the front and rear glass run channels 16 and 17 both of which are easy to result in the problem of producing noise during movement of window pane 14. In this case, too, a great deal of effect can be achieved as a counter measure against noise during movement of window pane 14.

Furthermore, the projecting ridges 31 may be provided on only the exterior sealing lip 25 which are easy to result in the problem of noise during movement of window pane 14. In this case, too, a great deal of effect can be achieved as a counter measure against noise during movement of window pane 14.

Furthermore, a plurality of projecting ridges 30 and 31 are disposed substantially in parallel to each other at predetermined intervals in the foregoing embodiment. As in another embodiment shown in FIG. 9, a plurality of projecting ridges 30 and 31 may be disposed substantially in parallel to each other while the intervals between the projecting ridges 30 and 31 are substantially zero. Furthermore, each of the projecting ridges 30 and 31 may be set so that the shorter side thereof has an inclination of substantially zero relative to a normal line passing an apex on the surface of each of the sealing lip bodies 26 and 27. Thus, disposition of each of the projecting ridges 30 and 31 and an inclination of each side may be changed suitably. For example, a plurality of projecting ridges 30 and 31 may be disposed at irregular intervals and in a curved shape. Furthermore, the projecting ridges 30 and 31 may not be continuous in the lengthwise direction but may be discontinuous.

Furthermore, although the projecting ridges 30 and 31 are formed on the surfaces of the low-frictional material layers 28 and 29 formed on the surfaces of the sealing lip bodies 26 and 27 in the foregoing embodiment respectively, the low-frictional material layers 28 and 29 may be eliminated and the projecting ridges 30 and 31 may be formed directly on the surfaces of the sealing lip bodies 26 and 27 respectively.

### INDUSTRIAL APPLICABILITY

A scope of application of the present invention should not be limited to glass run channels mounted on window frames of automobile doors. The present invention can be applied to glass run channels mounted on window frames of articles other than doors and the like, and glass run channels which are formed so as to guide slide movement of a window pane.

1. A long glass run channel which is made from an elastic polymer material, the glass run channel being mounted along a window frame of a vehicle and formed so as to guide a slide movement of a window pane, the glass run channel including:
a base bottom portion opposed to a peripheral end surface of the window pane when the glass run channel has been mounted on the window frame;
interior and exterior side wall portions standing from both ends of the base bottom portion in the width direction respectively; and
interior and exterior sealing lips protruding from distal end sides of the interior and exterior side wall portions toward widthwise substantially central sides of the base bottom portion respectively, the interior and exterior sealing lips being capable of abutting against the window pane when the glass run channel is mounted on the window frame, comprising:
at least one of the interior and exterior sealing lips includes a sealing lip body and a projecting ridge formed integrally on a surface of the sealing lip body so as to extend in a lengthwise direction; and
the projecting ridge has a cross section formed into a shape of substantially a scalene triangle including a longer side at a root side of the sealing lip and a shorter side at a distal end side of the sealing lip.

2. The glass run channel of claim 1, wherein the longer side of the projecting ridge is set so as to have an angle of inclination ranging from 40° to 80° relative to a normal line on the surface of the sealing lip body and the shorter side of the projecting ridge is set so as to have an angle of inclination ranging from 5° to 40° relative to the normal line.

3. The glass run channel of claim 2, wherein the shorter side of the projecting ridge is set so as to have an angle of inclination ranging from 15° to 40° relative to the normal line on the surface of the sealing lip body.

4. The glass run channel of claim 1, wherein the projecting ridge is made from a polymer material having a solubility with a polymer material of the sealing lip body and a better slidability than the polymer material of the sealing lip body and that the projecting ridge and the sealing lip body are integrated by welding.

5. The glass run channel of claim 1, wherein the polymer material of the sealing lip body is rubber.

6. The glass run channel of claim 1, wherein the polymer material of the sealing lip body is a thermoplastic elastomer.

7. The glass run channel of claim 6, wherein the thermoplastic elastomer of the sealing lip body is an olefinic thermoplastic elastomer.

8. The glass run channel of claim 1, wherein the projecting ridge is provided at least a surface of the exterior sealing lip body out of the interior and exterior sealing lips.

9. The glass run channel of claim 1, wherein the projecting ridges are provided on surfaces of both interior and exterior sealing lips respectively.

10. The glass run channel of claim 1, wherein the glass run channel includes an upper glass run channel mounted along an upper part of the window frame and a side glass run channel mounted along a side part of the window frame and that the projecting ridge is provided on the sealing lip of the side glass run channel.

11. The glass run channel of claim 1, wherein the glass run channel includes an upper glass run channel mounted along an upper part of the window frame and a side glass run channel mounted along a side part of the window frame and that the projecting ridges are provided on the sealing lips of both the upper glass run channel and the side glass run channel respectively.

12. The glass run channel of claim 1, wherein a plurality of the projecting ridges are provided substantially in parallel with each other along the lengthwise direction of the sealing lip.
